(19) United States
(12) Patent Application Publication
(10) Pub. No.: US 2023/0124449 A1
(43) Pub. Date: Apr. 20, 2023

(54) FLUID COMPOSITIONS FOR VARIABLE LENSES, VARIABLE LENSES, AND METHODS OF MANUFACTURING AND OPERATING VARIABLE LENSES

(71) Applicant: CORNING INCORPORATED, CORNING, NY (US)

(72) Inventors: Julie Colette Anduran, Oullins (FR); Benjamin Jean-Baptiste Francois Burger, Lyon (FR); Raymond Miller Karam, Santa Barbara, CA (US)

(21) Appl. No.: 17/912,215

(22) PCT Filed: Mar. 15, 2021
(86) PCT No.: PCT/US2021/022278

§ 371 Date: Sep. 16, 2022

Related U.S. Application Data
(60) Provisional application No. 62/990,128, filed on Mar. 16, 2020.

(51) Int. Cl. G02B 26/00; G02B 3/14

(52) U.S. Cl. CPC G02B 26/005; G02B 3/14

(57) ABSTRACT

A liquid lens can include a cavity between first and second windows, first and second liquids in the cavity, and a variable interface between the liquids, thereby forming a variable lens. The liquid lens can be operable to adjust a shape of the variable interface at an operating temperature less than a melting point of the first liquid. A liquid composition of the first liquid can include at least 65 wt. % water, at most 31 wt. % of a freezing point reducing agent, at most 20 wt. % of an alkali metal salt, a melting point of greater than or equal to −10° C., a viscosity of at most 1.3 cSt, measured at a temperature of 20° C., a refractive index, measured at a wavelength of 589.3 nm, of at most 1.4, and/or an Abbe number of at least 45. A volume of the cavity can be at most 10 μL.

### CROSS-REFERENCE TO RELATED APPLICATIONS

This application claims the benefit of priority under 35 U.S.C. § 371 to International Application No. PCT/US2021/022278, filed Mar. 15, 2021, which claims the benefit of priority under 35 U.S.C. § 119 to U.S. Provisional Application No. 62/990,128, filed Mar. 16, 2020, the content of each of which is incorporated herein by reference in its entirety.

### BACKGROUND

### 1. Field

This disclosure relates to fluid compositions for variable lenses, and more particularly, to variable lenses with improved performance, particularly at low operating temperatures.

### 2. Technical Background

Liquid lenses generally include two immiscible liquids disposed within a chamber. Varying the electric field to which the liquids are subjected can vary the wettability of one of the liquids with respect to the chamber wall, thereby varying the shape of the meniscus formed between the two liquids.

### SUMMARY

Disclosed herein are fluid compositions for variable lenses, variable lenses, and methods of manufacturing and operating variable lenses.

Disclosed herein is a liquid lens comprising a cavity disposed between a first window and a second window, a first liquid disposed in the cavity, a second liquid disposed in the cavity, and a variable interface disposed between the first liquid and the second liquid, thereby forming a variable lens. The liquid lens is operable to adjust a shape of the variable interface of the liquid lens at an operating temperature that is less than a melting point of a liquid composition of the first liquid at a standard pressure of 1 atm.

Disclosed herein is a liquid lens comprising a cavity disposed between a first window and a second window, a first liquid disposed in the cavity, a second liquid disposed in the cavity, and a variable interface disposed between the first liquid and the second liquid, thereby forming a variable lens. In some embodiments, a viscosity of the first liquid is at most 1.3 cSt, measured at a temperature of 20° C. Additionally, or alternatively, a refractive index of the first liquid, measured at a wavelength of 589.3 nm, is at most 1.4. Additionally, or alternatively, an Abbe number of the first liquid is at least 45. Additionally, or alternatively, a volume of the cavity is at most 10 μL.

Disclosed herein is a liquid for use in a variable focus fluidic lens, the liquid comprising a liquid composition comprising at least 65 wt. % water, at most 31 wt. % of a freezing point reducing agent, and at most 20 wt. % of an alkali metal salt. In some embodiments, the liquid composition comprises a melting point, measured at a standard pressure of 1 atm, of greater than or equal to −10° C. Additionally, or alternatively, the liquid composition comprises a viscosity of at most 1.3 cSt. Additionally, or alternatively, the liquid composition comprises a refractive index, measured at a wavelength of 589.3 nm, of at most 1.4. Additionally, or alternatively, the liquid composition comprises an Abbe number of at least 45. Additionally, or alternatively, the liquid composition comprises a change in density over a temperature range from 0° C. to 60° C. at the standard pressure of 1 atm of at most 0.028 cm³/g.

Disclosed herein is a method of operating a liquid lens, the method comprising adjusting an applied voltage to adjust a variable interface between a first liquid and a second liquid each disposed in a cavity of the liquid lens, thereby adjusting at least one of a focus or a tilt of the liquid lens, wherein the adjusting is performed at an operating temperature that is less than a melting point of a liquid composition of the first liquid at a standard pressure of 1 atm.

It is to be understood that both the foregoing general description and the following detailed description are merely exemplary, and are intended to provide an overview or framework to understanding the nature and character of the claimed subject matter. The accompanying drawings are included to provide a further understanding and are incorporated in and constitute a part of this specification. The drawings illustrate one or more embodiment(s), and together with the description, serve to explain principles and operation of the various embodiments.

### BRIEF DESCRIPTION OF THE DRAWINGS

FIG. 1 is a schematic cross-sectional view of some embodiments of a liquid lens.

FIG. 2 is a schematic cross-sectional view of some embodiments of the liquid lens shown in FIG. 1 with a varied focal length compared to FIG. 1.

FIG. 3 is a schematic cross-sectional view of some embodiments of the liquid lens shown in FIG. 1 with a varied tilt compared to FIG. 1.

FIG. 4 is a schematic front view of some embodiments of the liquid lens shown in FIG. 1 looking through a first outer layer of the liquid lens.

FIG. 5 is a schematic rear view of some embodiments of the liquid lens shown in FIG. 1 looking through a second outer layer of the liquid lens.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

Numerical values, including endpoints of ranges, can be expressed herein as approximations preceded by the term “about,” “approximately,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint.

As used herein, the term “weight percent” or “wt. %” means the ratio of the mass of a particular component of a composition to the total mass of the composition. For example, a composition with 65 wt. % water comprises 65 g of water per 100 g of the composition.

As used herein, the term “melting point” means the temperature at which a solid melts to become a liquid, and the term “freezing point” means the temperature at which a liquid freezes to become a solid. Unless otherwise specified, the melting point of a composition refers to the melting point at a standard pressure of 1 atm, and the freezing point of a composition refers to the freezing point in situ. The freezing point of the composition can depend on extrinsic factors (e.g., the volume of liquid, the surface properties of the vessel, etc.). Although the melting point and the freezing point of the composition typically are equal or substantially equal to each other, there are situations in which they can differ, sometimes significantly. For example, although it can be difficult to increase the temperature above which a solid can be heated without the solid melting to become a liquid (e.g., increasing the melting point), it can be possible to cool a liquid below the melting point of the composition without the liquid freezing to become a solid (e.g., decreasing the freezing point). In such a situation, the freezing point of the liquid can be less than the melting point of the solid. Such a liquid present at a temperature below the melting point of the composition can be said to be supercooled.

As used herein, the term “viscosity” means kinematic viscosity, which can be determined as described in DIN 53019, Viscometry—Measurement of viscosities and flow curves by means of rotational viscometers. The viscosities reported herein were measured using a rheometer commercially available under the trade name MCR 72 from Anton Paar, Graz, Austria.

As used herein, the term “focus response time” means the time in which a liquid lens subjected to a step impulse voltage signal corresponding to a transition from an initial focus of 0 diopter to a final focus of 30 diopter moves from 10% of the transition (e.g., 3 diopter) to 90% of the transition (e.g., 27 diopter). The focus response time can be referred to as the 10-90 focus response time of the liquid lens.

As used herein, the term “tilt response time” means the time in which a liquid lens subjected to a step impulse voltage signal corresponding to a transition from a physical tilt of 0 degrees to a physical tilt of 0.37 degrees moves from 10% of the transition to 90% of the transition, where 100% of the transition is set as the physical tilt 150 ms after applying the step impulse voltage signal. The tilt response time can be referred to as the 10-90 tilt response time of the liquid lens.

As used herein, the term “capacitance drift” means the change in the detected capacitance between a common electrode of a liquid lens and a driving electrode of the liquid lens upon performing a capacitance drift test. The capacitance drift test comprises (a) ramping the driving voltage applied to the liquid lens linearly from a minimum operating voltage to a maximum operating voltage over a first ramp period of 1 minute, (b) ramping the driving voltage linearly from the maximum operating voltage back to the minimum operating voltage over a second ramp period of 1 minute, (c) holding the voltage at the minimum operating voltage for a hold period of 2 minutes, and (d) repeating steps a to c over a test period of 30 minutes. The capacitance drift is the difference between the minimum capacitance measured during any of the hold periods and the maximum capacitance measured during any of the hold periods.

As used herein, the term “transmission recovery time” means the time in which the turbidity of the liquids in a liquid lens (or a sample of the liquids outside of the liquid lens) returns to within 10% of its initial value after thermally shocking the liquid lens (or the sample of the liquids) by heating from an initial temperature of −20° C. to a final temperature of 30° C. over a heating period of 2 minutes. Turbidity of the liquids can be determined as described in D7315— Standard Test Method for Determination of Turbidity Above 1 Turbidity Unit (TU) in Static Mode.

As used herein, the term “surface roughness” means Ra surface roughness, which can be determined as described in ISO 25178, Geometric Product Specifications (GPS)— Surface texture: areal, filtered at 25 μm.

In various embodiments, a liquid lens comprises a cavity disposed between a first window and a second window, a first liquid disposed in the cavity, a second liquid disposed in the cavity, and a variable interface disposed between the first liquid and the second liquid, thereby forming a variable lens. The liquid lens can be operable to adjust a shape of the variable interface of the liquid lens at an operating temperature that is less than a melting point of a liquid composition of the first liquid at a standard pressure of 1 atm. In some embodiments, a viscosity of the first liquid is at most 1.3 cSt, measured at a temperature of 20° C. Additionally, or alternatively, a refractive index of the first liquid, measured at a wavelength of 589.3 nm, is at most 1.4. Additionally, or alternatively, an Abbe number of the first liquid is at least 45. Additionally, or alternatively, a volume of the cavity is at most 10 μL.

In various embodiments, a liquid for use in a variable focus fluidic lens comprises a liquid composition comprising at least 65 wt. % water, at most 31 wt. % of a freezing point reducing agent, and at most 20 wt. % of an alkali metal salt. In some embodiments, the liquid composition comprises a melting point, measured at a standard pressure of 1 atm, of greater than or equal to −10° C. Additionally, or alternatively, the liquid composition comprises a viscosity of at most 1.3 cSt. Additionally, or alternatively, the liquid composition comprises a refractive index, measured at a wavelength of 589.3 nm, of at most 1.4. Additionally, or alternatively, the liquid composition comprises an Abbe number of at least 45. Additionally, or alternatively, the liquid composition comprises a change in density over a temperature range from 0° C. to 60° C. at the standard pressure of 1 atm of at most 0.028 cm3/g.

In various embodiments, a method of operating a liquid lens comprises adjusting an applied voltage to adjust a variable interface between a first liquid and a second liquid each disposed in a cavity of the liquid lens, thereby adjusting at least one of a focus or a tilt of the liquid lens, wherein the adjusting is performed at an operating temperature that is less than a melting point of a liquid composition of the first liquid at a standard pressure of 1 atm.

The fluid compositions and variable lens configurations described herein can enable operation of the variable lenses over a wide operating temperature range (e.g., −20° C. to 60° C.) while maintaining suitable performance. In particular, the combination of the fluid compositions and the variable lens configurations described herein can enable operation of the variable lenses at the lower end of the operating temperature range, even though the fluid compositions would be expected to freeze at such low temperatures and prevent operation of the variable lenses. In some embodiments, the variable lenses described herein are operable to vary the focus and/or tilt of the variable interfaces at operating temperatures below the melting points of the fluid compositions (e.g., the compositions of the polar fluids or the conductive fluids) disposed within the variable lenses. Use of fluid compositions with melting points that are higher than such operating temperatures can enable such variable lenses to have improved performance (e.g., acceptably low refractive index, acceptably high Abbe number, acceptably low capacitance drift, low focus and/or tilt response time, and/or low transmission recovery time) while maintaining the desired operating temperature range (e.g., without freezing). Additives can be included in fluid compositions for use in variable lenses to depress the melting points and/or freezing points of the fluids. However, such additives can impair the performance of the variable lenses. Fluid compositions with reduced concentrations of such additives can be used in variable lenses as described herein to improve performance of the variable lenses while also avoiding the freezing of the fluids that would be expected at low operating temperatures. The fluid compositions can be combined synergistically with variable lens configurations (e.g., small cavity volume and/or low cavity sidewall surface roughness) to help to enable such low temperature operation and/or lens performance.

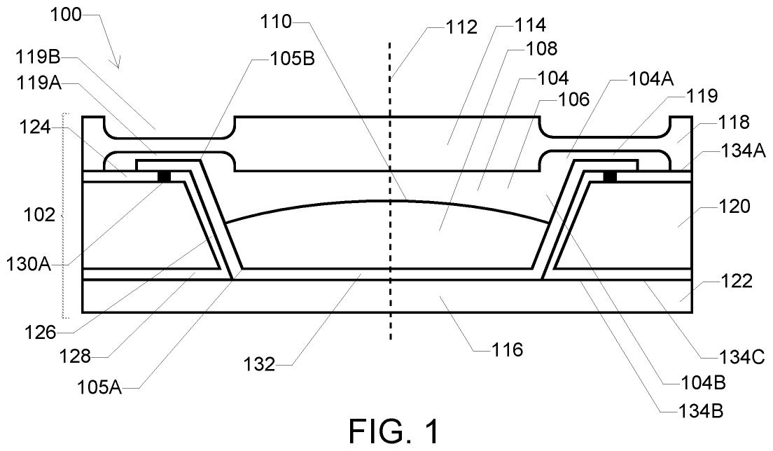

FIG. 1 is a schematic cross-sectional view of some embodiments of a liquid lens 100. In some embodiments, liquid lens 100 comprises a lens body 102 and a cavity 104 formed or disposed in the lens body. A first liquid 106 and a second liquid 108 are disposed within cavity 104. In some embodiments, first liquid 106 is a polar liquid or a conducting liquid (e.g., an aqueous salt solution). Additionally, or alternatively, second liquid 108 is a non-polar liquid or an insulating liquid (e.g., an oil). In some embodiments, first liquid 106 and second liquid 108 have different refractive indices such that an interface 110 between the first liquid and the second liquid forms a lens. In some embodiments, first liquid 106 and second liquid 108 have substantially the same density, which can help to avoid changes in the shape of interface 110 as a result of changing the physical orientation of liquid lens 100 (e.g., as a result of gravitational forces).

In some embodiments, first liquid 106 and second liquid 108 are in direct contact with each other at interface 110. For example, first liquid 106 and second liquid 108 are substantially immiscible with each other such that the contact surface between the first liquid and the second liquid defines interface 110. In some embodiments, first liquid 106 and second liquid 108 are separated from each other at interface 110. For example, first liquid 106 and second liquid 108 are separated from each other by a membrane (e.g., a polymeric membrane) that defines interface 110.

In some embodiments, cavity 104 comprises a first portion, or headspace, 104A and a second portion, or base portion, 104B. For example, second portion 104B of cavity 104 is defined by a bore in an intermediate layer of liquid lens 100 as described herein. Additionally, or alternatively, first portion 104A of cavity 104 is defined by a recess in a first outer layer of liquid lens 100 and/or disposed outside of the bore in the intermediate layer as described herein. In some embodiments, at least a portion of first liquid 106 is disposed in first portion 104A of cavity 104. Additionally, or alternatively, second liquid 108 is disposed within second portion 104B of cavity 104. For example, substantially all or a portion of second liquid 108 is disposed within second portion 104B of cavity 104. In some embodiments, the perimeter of interface 110 (e.g., the edge of the interface in contact with the sidewall of the cavity) is disposed within second portion 104B of cavity 104.

Interface 110 can be adjusted via electrowetting. For example, a voltage can be applied between first liquid 106 and a surface of cavity 104 (e.g., an electrode positioned near the surface of the cavity and insulated from the first liquid as described herein) to increase or decrease the wettability of the surface of the cavity with respect to the first liquid and change the shape of interface 110 as described herein. In some embodiments, a refractive index of first liquid 106 is different than a refractive index of second liquid 108 such that light is refracted at interface 110 as described herein. For example, first liquid 106 has a lower refractive index or a higher refractive index than second liquid 108. Thus, interface 110 can function as a variable lens also as described herein.

In some embodiments, lens body 102 of liquid lens 100 comprises a first window 114 and a second window 116. In some of such embodiments, at least a portion of cavity 104 is disposed between first window 114 and second window 116. In some embodiments, lens body 102 comprises a plurality of layers that cooperatively form the lens body. For example, in the embodiments shown in FIG. 1, lens body 102 comprises a first outer layer 118 (e.g., a top plate), an intermediate layer 120 (e.g., a cone plate), and a second outer layer 122 (e.g., a bottom plate). In some of such embodiments, intermediate layer 120 comprises a bore formed therethrough. First outer layer 118 can be bonded to one side (e.g., the object side or the top side) of intermediate layer 120. For example, first outer layer 118 is bonded to intermediate layer 120 at a bond 134A. Bond 134A can be an adhesive bond, a laser bond (e.g., a room temperature laser bond or a laser weld), or another suitable bond capable of maintaining first liquid 106 and second liquid 108 within cavity 104. Additionally, or alternatively, second outer layer 122 can be bonded to the other side (e.g., the image side or the bottom side) of intermediate layer 120 (e.g., opposite first outer layer 118). For example, second outer layer 122 is bonded to intermediate layer 120 at a bond 1346 and/or a bond 134C, each of which can be configured as described herein with respect to bond 134A. In some embodiments, intermediate layer 120 is disposed between first outer layer 118 and second outer layer 122, the bore in the intermediate layer is covered on opposing sides by the first outer layer and the second outer layer, and at least a portion of cavity 104 is defined within the bore. Thus, a portion of first outer layer 118 covering cavity 104 serves as first window 114, and a portion of second outer layer 122 covering the cavity serves as second window 116.

In some embodiments, cavity 104 comprises first portion 104A and second portion 104B. For example, in the embodiments shown in FIG. 1, second portion 104B of cavity 104 is defined by the bore in intermediate layer 120, and first portion 104A of the cavity is disposed between the second portion of the cavity and first outer layer 118. In some embodiments, first outer layer 118 comprises a recess 119 as shown in FIG. 1, and first portion 104A of cavity 104 is disposed within the recess in the first outer layer. In some embodiments, first portion 104A of cavity 104 is disposed outside of the bore in intermediate layer 120. In some embodiments, recess 119 comprises an annular internal recess 119A disposed on an inner surface (e.g., inside cavity 104) of first outer layer 118 and circumscribing or substantially circumscribing first window 114. In some embodiments, recess 119 comprises an annular external recess 119B disposed on an outer surface (e.g., outside cavity 104) of first outer layer 118 and circumscribing or substantially circumscribing first window 114. For example, in some embodiments, recess 119 comprises both internal recess 119A and external recess 119B as shown in FIG. 1. In some of such embodiments, a thinned portion of first outer layer 118 can serve as a flexure. For example, first window 114 comprises a thicker portion of first outer layer 118 circumscribed by the thinner flexure defined between internal recess 119A and external recess 119B. The flexure can enable first window 114 to move axially (e.g., up and down along structural axis 112). Such movement can enable first outer layer 118 to compensate for changes in the volume of first fluid 106 and/or second fluid 108 (e.g., resulting from temperature changes and corresponding expansion and/or contraction of the fluids).

In some embodiments, cavity 104, or a portion thereof (e.g., second portion 1046 of the cavity), is tapered as shown in FIG. 1 such that a cross-sectional area of the cavity decreases along a structural axis 112 of liquid lens 100 in a direction from first window 114 toward second window 116 (e.g., from the object side to the image side). For example, second portion 1046 of cavity 104 comprises a conical or frustoconical shape with a narrow end 105A and a wide end 1056. The terms “narrow” and “wide” are relative terms, meaning the narrow end is narrower, or has a smaller width or diameter, than the wide end. Such a tapered cavity can help to maintain alignment of interface 110 between first liquid 106 and second liquid 108 along structural axis 112. In other embodiments, the cavity is tapered such that the cross-sectional area of the cavity increases along the structural axis in the direction from first window 114 toward second window 116 or non-tapered such that the cross-sectional area of the cavity remains substantially constant along the structural axis. In some embodiments, cavity 104 is rotationally symmetrical about structural axis 112.

In some embodiments, image light enters liquid lens 100 through first window 114, is refracted at interface 110 between first liquid 106 and second liquid 108, and exits the liquid lens through second window 116. In some embodiments, first outer layer 118 and/or second outer layer 122 comprise a sufficient transparency to enable passage of the image light. For example, first outer layer 118 and/or second outer layer 122 comprise a polymeric, glass, ceramic, or glass-ceramic material. In some embodiments, outer surfaces of first outer layer 118 and/or second outer layer 122 are substantially planar. Thus, even though liquid lens 100 can function as a lens (e.g., by refracting image light passing through interface 110), outer surfaces of the liquid lens can be flat as opposed to being curved like the outer surfaces of a fixed lens. Such planar outer surfaces can make integrating liquid lens 100 into an optical assembly (e.g., a lens stack comprising one or more fixed lenses disposed in a housing or lens barrel) less difficult. In other embodiments, outer surfaces of the first outer layer and/or the second outer layer are curved (e.g., concave or convex). Thus, the liquid lens can comprise an integrated fixed lens. In some embodiments, intermediate layer 120 comprises a metallic, polymeric, glass, ceramic, or glass-ceramic material. Because image light can pass through the bore in intermediate layer 120, the intermediate layer may or may not be transparent.

Although lens body 102 of liquid lens 100 is described as comprising first outer layer 118, intermediate layer 120, and second outer layer 122, other embodiments are included in this disclosure. For example, in some other embodiments, one or more of the layers is omitted. For example, the bore in the intermediate layer can be configured as a blind hole that does not extend entirely through the intermediate layer, and the second outer layer can be omitted. Although first portion 104A of cavity 104 is described herein as being disposed within the recess in first outer layer 118, other embodiments are included in this disclosure. For example, in some other embodiments, the recess is omitted, and the first portion of the cavity is disposed within the bore in the intermediate layer. Thus, the first portion of the cavity is an upper portion of the bore, and the second portion of the cavity is a lower portion of the bore. In some other embodiments, the first portion of the cavity is disposed partially within the bore in the intermediate layer and partially outside the bore.

In some embodiments, liquid lens 100 comprises a common electrode 124 in electrical communication with first liquid 106. Additionally, or alternatively, liquid lens 100 comprises a driving electrode 126 disposed on a sidewall of cavity 104 and insulated from first liquid 106 and second liquid 108. Different voltages can be supplied to common electrode 124 and driving electrode 126 (e.g., different potentials can be supplied between the common electrode and the driving electrode) to change the shape of interface 110 as described herein.

In some embodiments, liquid lens 100 comprises a conductive layer 128 at least a portion of which is disposed within cavity 104. For example, conductive layer 128 comprises a conductive coating applied to intermediate layer 120 prior to bonding first outer layer 118 and/or second outer layer 122 to the intermediate layer. Conductive layer 128 can comprise a metallic material, a conductive polymer material, another suitable conductive material, or a combination thereof. Additionally, or alternatively, conductive layer 128 can comprise a single layer or a plurality of layers, some or all of which can be conductive. In some embodiments, conductive layer 128 defines common electrode 124 and/or driving electrode 126. For example, conductive layer 128 can be applied to substantially the entire outer surface of intermediate layer 118 prior to bonding first outer layer 118 and/or second outer layer 122 to the intermediate layer. Following application of conductive layer 128 to intermediate layer 118, the conductive layer can be segmented into various conductive elements (e.g., common electrode 124, driving electrode 126, and/or other electrical devices). In some embodiments, liquid lens 100 comprises a scribe 130A in conductive layer 128 to isolate (e.g., electrically isolate) common electrode 124 and driving electrode 126 from each other. In some embodiments, scribe 130A comprises a gap in conductive layer 128. For example, scribe 130A is a gap with a width of about 5 μm, about 10 μm, about 15 μm, about 20 μm, about 25 μm, about 30 μm, about 35 μm, about 40 μm, about 45 μm, about 50 μm, or any ranges defined by the listed values.

In some embodiments, liquid lens 100 comprises an insulating layer 132 disposed within cavity 104. For example, insulating layer 132 comprises an insulating coating applied to intermediate layer 120 and second outer layer 122 prior to bonding first outer layer 118 to the intermediate layer. In some embodiments, insulating layer 132 comprises an insulating coating applied to conductive layer 128 and second window 116 after bonding second outer layer 122 to intermediate layer 120 and prior to bonding first outer layer 118 to the intermediate layer. Thus, insulating layer 132 covers at least a portion of conductive layer 128 within cavity 104 (e.g., driving electrode 126) and second window 116. In some embodiments, insulating layer 132 can be sufficiently transparent to enable passage of image light through second window 116 as described herein. Insulating layer 132 can comprise polytetrafluoroethylene (PTFE), parylene, another suitable polymeric or non-polymeric insulating material, or a combination thereof. Additionally, or alternatively, insulating layer 132 comprises a hydrophobic material. Additionally, or alternatively, insulating layer 132 can comprise a single layer or a plurality of layers, some or all of which can be insulating and/or hydrophobic.

In some embodiments, insulating layer 132 covers at least a portion of driving electrode 126 (e.g., the portion of the driving electrode disposed within cavity 104) to insulate first liquid 106 and second liquid 108 from the driving electrode. Additionally, or alternatively, at least a portion of common electrode 124 disposed within cavity 104 is uncovered by insulating layer 132. Thus, common electrode 124 can be in electrical communication with first liquid 106 as described herein. In some embodiments, insulating layer 132 comprises a hydrophobic surface layer of at least a portion of cavity 104 (e.g., second portion 104B of the cavity). Such a hydrophobic surface layer can help to maintain second liquid 108 within second portion 104B of cavity 104 (e.g., by attraction between the non-polar second liquid and the hydrophobic material) and/or enable the perimeter of interface 110 to move along the hydrophobic surface layer (e.g., by electrowetting) to change the shape of the interface as described herein.

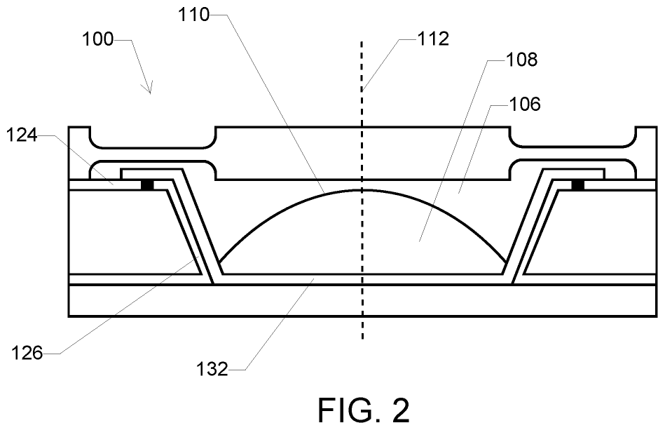

In some embodiments, adjusting interface 110 changes the shape of the interface, which changes the focal length or focus of liquid lens 100. FIG. 2 is a cross-sectional schematic view of liquid lens 100 with an adjusted focal length or focus compared to FIG. 1. For example, the voltage or potential between driving electrode 126 and common electrode 124 can be increased to increase the wettability of insulating layer 132 with respect to first liquid 106, thereby driving the first liquid farther down the sidewall and causing interface 110 to change shape. In some embodiments, the refractive index of first liquid 106 is less than the refractive index of second liquid 108 such that increasing the convex curvature of interface 110 as shown in FIG. 2 increases the optical power of liquid lens 100. In some embodiments, decreasing the voltage can move interface 110 in the opposite direction to decrease the optical power of liquid lens 100. For example, interface 110 can be moved in the opposite direction until the interface becomes flat (e.g., no optical power) or even concave (e.g., negative optical power). In some embodiments, the change in shape of interface 110 can be symmetrical about structural axis 112, thereby changing the focal length of liquid lens 100. Such a change of focal length can enable liquid lens 100 to perform a focus, a zoom, and/or an autofocus function.

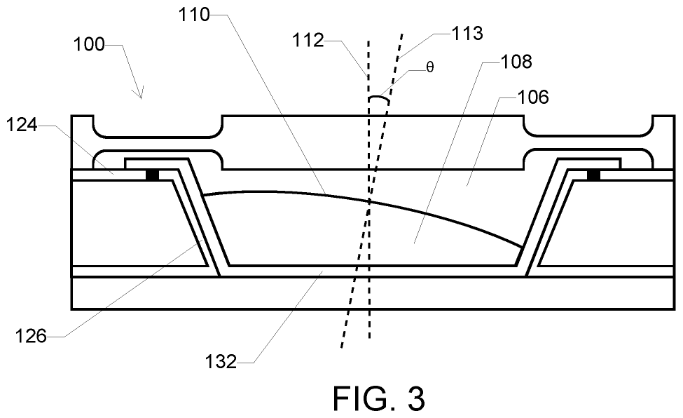

In some embodiments, adjusting interface 110 tilts the interface relative to structural axis 112 of liquid lens 100. FIG. 3 is a cross-sectional schematic view of liquid lens 100 with an adjusted tilt compared to FIG. 1. For example, the voltage between a first portion of driving electrode 126 (e.g., a third driving electrode segment 126C as described herein, positioned on a right side of cavity 104) and common electrode 124 can be increased to increase the wettability of insulating layer 132 with respect to first liquid 106, thereby driving the first liquid farther down the sidewall on one side of the cavity, while the voltage between a second portion of the driving electrode opposite the first portion of the driving electrode (e.g., a first driving electrode segment 126A as described herein, positioned on a left side of the cavity) and the common electrode can be decreased to decrease the wettability of the insulating layer with respect to the first liquid, thereby driving the first liquid farther up the sidewall on an opposite side of the cavity. Following such a change in shape of interface 110, a physical tilt angle θ can be formed between an optical axis 113 of the interface and structural axis 112. For example, optical axis 113 of the tilted interface 110 can be angled relative to structural axis 112 at physical tilt angle θ. An optical tilt angle of liquid lens 100 can be determined based on physical tilt angle θ and the difference in refractive index between first liquid 106 and second liquid 108. The optical tilt angle can be representative of a degree to which interface 110 can refract or redirect light passing through liquid lens 100. Such tilting can enable liquid lens 100 to perform an optical image stabilization (01S) function. Adjusting interface 110 can be achieved without physical movement of liquid lens 100 relative to an image sensor, a fixed lens or lens stack, a housing, or other components of a camera module in which the liquid lens can be incorporated.

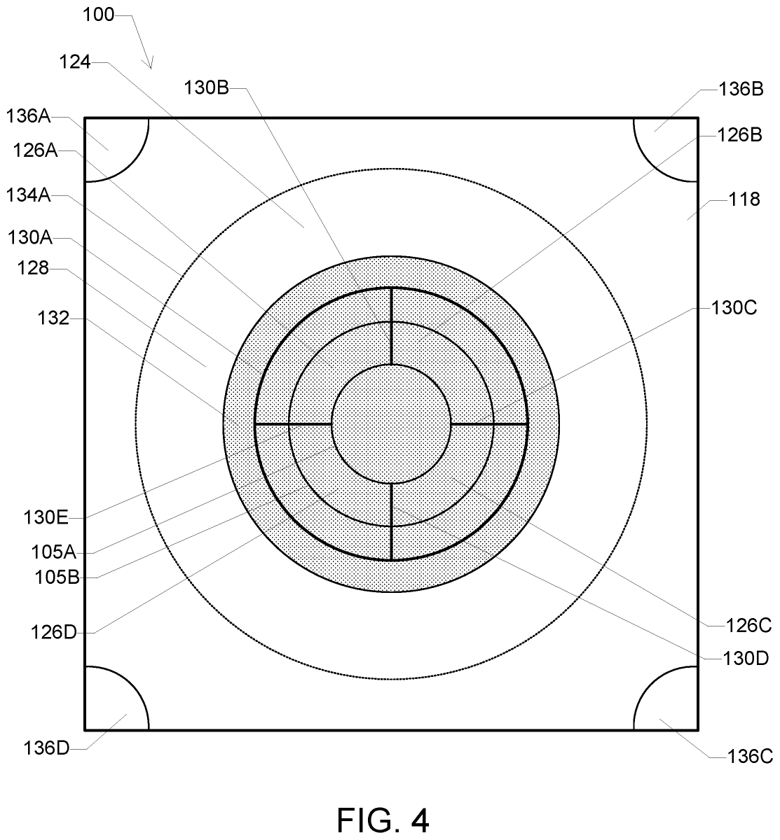

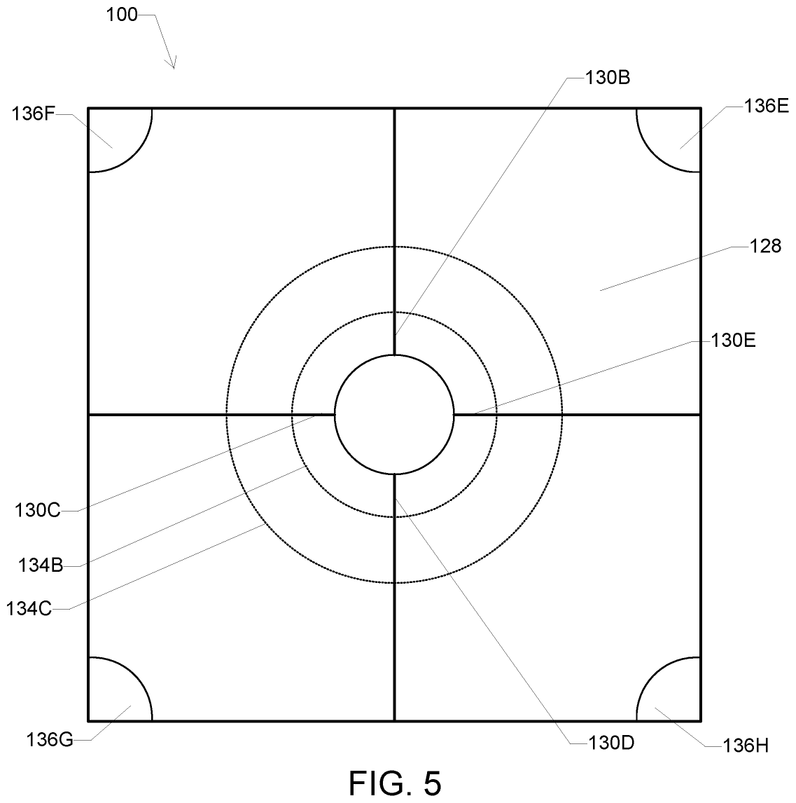

FIG. 4 is a schematic front view of liquid lens 100 looking through first outer layer 118, and FIG. 5 is a schematic rear view of the liquid lens looking through second outer layer 122. For clarity in FIGS. 4 and 5, and with some exceptions, bonds generally are shown in dashed lines, scribes generally are shown in heavier lines, and other features generally are shown in lighter lines.

In some embodiments, common electrode 124 is defined between scribe 130A and bond 134A, and a portion of the common electrode is uncovered by insulating layer 132 such that the common electrode can be in electrical communication with first liquid 106 as described herein. In some embodiments, bond 134A is configured such that electrical continuity is maintained between the portion of conductive layer 128 inside the bond (e.g., inside cavity 104) and the portion of the conductive layer outside the bond (e.g., outside the cavity). In some embodiments, liquid lens 100 comprises one or more cutouts 136 in first outer layer 118. For example, in the embodiments shown in FIG. 4, liquid lens 100 comprises a first cutout 136A, a second cutout 136B, a third cutout 136C, and a fourth cutout 136D. In some embodiments, cutouts 136 comprise portions of liquid lens 100 at which first outer layer 118 is removed to expose conductive layer 128. Thus, cutouts 136 can enable electrical connection to common electrode 124, and the regions of conductive layer 128 exposed at the cutouts can serve as contacts to enable electrical connection of liquid lens 100 to a controller, a driver, or another component of a lens or camera system.

Although cutouts 136 are described herein as being positioned at corners of liquid lens 100, other embodiments are included in this disclosure. For example, in some embodiments, one or more of the cutouts are disposed inboard of the outer perimeter of the liquid lens and/or along one or more edges of the liquid lens.

In some embodiments, driving electrode 126 comprises a plurality of driving electrode segments. For example, in the embodiments shown in FIGS. 4 and 5, driving electrode 126 comprises a first driving electrode segment 126A, a second driving electrode segment 126B, a third driving electrode segment 126C, and a fourth driving electrode segment 126D. In some embodiments, the driving electrode segments are distributed substantially uniformly about the sidewall of cavity 104. For example, each driving electrode segment occupies about one quarter, or one quadrant, of the sidewall of second portion 1046 of cavity 104. In some embodiments, adjacent driving electrode segments are isolated from each other by a scribe. For example, first driving electrode segment 126A and second driving electrode segment 126B are isolated from each other by a scribe 130B. Additionally, or alternatively, second driving electrode segment 126B and third driving electrode segment 126C are isolated from each other by a scribe 130C. Additionally, or alternatively, third driving electrode segment 126C and fourth driving electrode segment 126D are isolated from each other by a scribe 130D. Additionally, or alternatively, fourth driving electrode segment 126D and first driving electrode segment 126A are isolated from each other by a scribe 130E. The various scribes 130 can be configured as described herein in reference to scribe 130A. In some embodiments, the scribes between the various electrode segments extend beyond cavity 104 and onto the back side of liquid lens 100 as shown in FIG. 5. Such a configuration can ensure electrical isolation of the adjacent driving electrode segments from each other. Additionally, or alternatively, such a configuration can enable each driving electrode segment to have a corresponding contact for electrical connection as described herein.

Although driving electrode 126 is described herein as being divided into four driving electrode segments, other embodiments are included in this disclosure. In some other embodiments, the driving electrode comprises a single driving electrode (e.g., substantially circumscribing the sidewall of the cavity). For example, the liquid lens comprising the such a single driving electrode can be capable of varying focal length, but incapable of tilting the interface (e.g., an autofocus only liquid lens). In some other embodiments, the driving electrode is divided into two, three, five, six, seven, eight, or more driving electrode segments (e.g., distributed substantially uniformly about the sidewall of the cavity).

In some embodiments, bond 134B and/or bond 134C are configured such that electrical continuity is maintained between the portion of conductive layer 128 inside the respective bond and the portion of the conductive layer outside the respective bond. In some embodiments, liquid lens 100 comprises one or more cutouts 136 in second outer layer 122. For example, in the embodiments shown in FIG. 5, liquid lens 100 comprises a fifth cutout 136E, a sixth cutout 136F, a seventh cutout 136G, and an eighth cutout 136H. In some embodiments, cutouts 136 comprise portions of liquid lens 100 at which second outer layer 122 is removed to expose conductive layer 128. Thus, cutouts 136 can enable electrical connection to driving electrode 126, and the regions of conductive layer 128 exposed at cutouts 136 can serve as contacts to enable electrical connection of liquid lens 100 to a controller, a driver, or another component of a lens or camera system.

Different driving voltages can be supplied to different driving electrode segments to tilt the interface of the liquid lens (e.g., for OIS functionality). Additionally, or alternatively, a driving voltage can be supplied to a single driving electrode or the same driving voltage can be supplied to each driving electrode segment to maintain the interface of the liquid lens in a substantially spherical orientation about the structural axis (e.g., for zoom, focus, and/or autofocus functionality).

In some embodiments, liquid lens 100 is configured to be operable even at low operating temperatures at which first liquid 106 would be expected to freeze (e.g., below the melting point of first liquid 106), thereby preventing operation of the liquid lens. Additionally, or alternatively, liquid lens 100 is configured to enable a sufficiently fast focus and/or tilt response time to enable the liquid lens to be used for autofocus and/or OIS even at such low operating temperatures (e.g., below the melting point of first liquid 106).

In some embodiments, first liquid 106 is polar and/or conductive, second liquid 108 is non-polar and/or non-conductive, and the first liquid and the second liquid are substantially immiscible with each other as described herein. In some of such embodiments, first liquid 106 comprises water or an aqueous solution. Additionally, or alternatively, second liquid 108 comprises an oil.

In some applications, it may be beneficial for liquid lens 100 to operate (e.g., to change the shape of interface 110 to adjust the focus and/or the tilt of the liquid lens) at low operating temperatures. For example, in consumer electronics applications (e.g., smartphones, tablet computers, laptop computers, action cameras, drones, augmented reality (AR) and/or virtual reality (VR) devices, etc.), a specified operating temperature range for liquid lens 100 can be −20° C. to 60° C. In some embodiments, first liquid 106 comprises an aqueous solution as described herein. Pure water generally freezes at the lower end of such an operating temperature range, which would prevent low temperature operation of liquid lens 100. Additives can be included in the water to make an aqueous solution for use as first liquid 106 with a depressed melting point and/or freezing point to enable low temperature operation of liquid lens 100. However, if the concentration of additives in first liquid 106 is sufficient to depress the melting point of the aqueous solution below the lower end of the operating temperature range, such additives can adversely affect the performance (e.g., the response time, electrical properties, and/or optical properties) of liquid lens 100. Surprisingly, liquid lens 100 configurations described herein can enable the liquid lens to operate at operating temperatures below the melting point of first liquid 106 without the first liquid freezing. Thus, liquid lens 100 configurations described herein can be used with first liquid 106 having a reduced concentration of additives, and therefore a higher melting point, than previously thought possible for low temperature applications. Such liquid lens 100 configurations can enable improved performance, even when operating at low operating temperatures.

Although pure water is polar, it has a conductivity of 0.055 μS/cm at 25° C. and a resistivity of 18.2 MΩ·cm at 25° C. Such low conductivity and high resistivity can be unsuitable for use as first liquid 106. Thus, it may be beneficial to add one or more components (e.g., a salt and/or a freezing point reducing agent) to pure water to increase the conductivity and/or decrease the resistivity of the water for use as first liquid 106. Pure water has a melting point (and generally also a freezing point) of 0° C. at a standard pressure of 1 atm, which can be high for use as first liquid 106. Thus, it may be beneficial to add one or more components (e.g., a salt and/or a freezing point reducing agent) to pure water to depress the melting point and/or freezing point of the water for use as first liquid 106.

In some embodiments, first liquid 106 comprises water, an alkali metal salt, and/or a freezing point reducing agent. The alkali metal salt can be added to increase the conductivity and/or decrease the resistivity, increase the density, and/or decrease the melting point and/or freezing point of first liquid 106. In some embodiments, the alkali metal salt is selected from the group consisting of an alkali metal bromide, an alkali metal acetate, an alkali metal sulfate, and combinations thereof. For example, the alkali metal salt is selected from the group consisting of lithium bromide, sodium bromide, potassium acetate, sodium sulfate, and combinations thereof. The freezing point reducing agent can be added to increase the conductivity and/or decrease the resistivity, increase the density, and/or decrease the melting point and/or freezing point of first liquid 106. In some embodiments, the freezing point reducing agent is selected from the group consisting of a diol, a triol, a sulfoxide, a lactone, and combinations thereof. For example, the freezing point reducing agent is selected from the group consisting of ethylene glycol, propylene glycol, 1,3-propanediol, glycerol, dimethyl sulfoxide (DMSO), ethyl-lactate, γ-butyrolactone, and combinations thereof.

Although first liquid 106 can comprise the alkali metal salt and/or the freezing point reducing agent to improve the conductivity, resistivity, density, melting point, and/or freezing point, the alkali metal salt and/or the freezing point reducing agent also can have a negative impact on the performance of liquid lens 100. For example, although a high concentration of the alkali metal salt can help to enable first liquid 106 to have a sufficiently high conductivity, low resistivity, and/or low melting point and/or freezing point, such a high concentration can lead to corrosion (e.g., of metallic components inside liquid lens 100, such as common electrode 124) or other damage to the liquid lens. Additionally, or alternatively, although a high concentration of the freezing point reducing agent can help to enable first liquid 106 to have a sufficiently low melting point and/or freezing point, such a high concentration can lead to liquid lens 100 having an unacceptably high capacitance drift, low response time, and/or high transmission recovery time.

Surprisingly, liquid lens 100 configurations described herein can enable concentrations of the alkali metal salt and/or the freezing point reducing agent in first liquid 106 to be reduced while still enabling operation of liquid lens 100 at low operating temperatures. For example, liquid lens 100 can be configured as described herein to enable operation of the liquid lens at an operating temperature below the melting point of first liquid 106. Surprisingly, such operation can be achieved without first liquid 106 freezing as would be expected based on the melting point of the composition of the first liquid. For example, first liquid 106 can be present within liquid lens 100 as a supercooled liquid rather than a solid at such low operating temperatures, thereby enabling continued operation of the liquid lens. Liquid lens 100 with first liquid 106 having reduced concentrations of the alkali metal salt and/or the freezing point reducing agent as described herein can enable low temperature operation of the liquid lens while avoiding the high capacitance drift, response time, and/or transmission recovery time that may otherwise be expected of liquid lenses capable of operating at such low temperatures.

In some embodiments, liquid lens 100 is operable to adjust the shape of the variable interface 110 at an operating temperature that is less than the melting point of the liquid composition of first liquid 106. For example, the operating temperature is 0° C., −5° C., −10° C., −15° C., −20° C., −25° C., −30° C., −35° C., −40° C., or any ranges defined by the listed values. In some embodiments, the melting point of the liquid composition of first liquid 106 is greater than or equal to the operating temperature. For example, the melting point of the liquid composition of first liquid 106 is −40° C., −35° C., −30° C., −25° C., −20° C., −15° C., −10° C., −5° C., 0° C., 5° C., 10° C., >10° C., or any ranges defined by the listed values. In some embodiments, liquid lens 100 is operable to change or adjust at least one of a focus or a tilt of the variable lens (e.g., by adjusting the voltage signal as described herein) at the operating temperature that is less than the melting point of the liquid composition of first liquid 106. In some embodiments, the melting point of the liquid composition of first liquid 106 is greater than the operating temperature, and the difference between the melting point and the operating temperature is 0° C., 1° C., 2° C., 3° C., 4° C., 5° C., 10° C., 15° C., 20° C., 25° C., 30° C., 40° C., 50° C., >50° C., or any ranges defined by the listed values. In some embodiments, at the operating temperature (e.g., the low operating temperature defining the lower end of the operating temperature range), first liquid 106 can remain in a liquid (e.g., unfrozen) state, which can enable such operation of liquid lens 100 at the operating temperature. For example, at the operating temperature, first liquid 106 can be present as a supercooled liquid that responds to changing voltages to change the shape of interface 110 as described herein.

In some embodiments, the liquid composition of first liquid 106 comprises at least 65 wt. % water. For example, the concentration of water in the liquid composition of first liquid 106 can be 65 wt. %, 70 wt. %, 75 wt. %, 80 wt. %, 85 wt. %, 90 wt. %, 95 wt. %, 96 wt. %, 97 wt. %, 98 wt. %, 99 wt. %, 100 wt. % or any ranges defined by the listed values.

In some embodiments, the liquid composition of first liquid 106 comprises at most 31 wt. % of the freezing point reducing agent. For example, the concentration of the freezing point reducing agent in the liquid composition of first liquid 106 can be 31 wt. %, 30 wt. %, 25 wt. %, 20 wt. %, 15 wt. %, 10 wt. %, 5 wt. %, 4 wt. %, 3 wt. %, 2 wt. %, 1 wt. %, 0 wt. %, or any ranges defined by the listed values.

In some embodiments, the liquid composition of first liquid 106 comprises at most 20 wt. % of the alkali metal salt. For example, the concentration of the alkali metal salt in the liquid composition of first liquid 106 can be 20 wt. %, 15 wt. %, 10 wt. %, 8 wt. %, 6 wt. %, 5 wt. %, 4 wt. %, 3 wt. %, 2 wt. %, 1 wt. %, 0 wt. %, or any ranges defined by the listed values.

In some embodiments, the liquid composition of first liquid 106 consists essentially of or consists of water, the freezing point reducing agent, and the alkali metal salt. For example, the combined concentration of water, the freezing point reducing agent, and the alkali metal salt in the liquid composition of first liquid 106 can be 90 wt. %, 95 wt. %, 96 wt. %, 97 wt. %, 98 wt. %, 99 wt. %, 100 wt. %, or any ranges defined by the listed values.

In some embodiments, reducing the concentration of additives in first liquid 106 can reduce the degree to which the volume of the first liquid changes with temperature. As the temperature of liquid lens 100 changes, the liquids inside cavity 104 can expand or contract. In some embodiments, first window 114 is configured to move as described herein to accommodate for such expansion or contraction of the liquids. Reducing the degree to which the volumes of first liquid 106 and/or second liquid 108 change with temperature can reduce the amount of expansion or contraction for which liquid lens 100 may be designed to accommodate. For example, reducing the degree to which the volumes of first liquid 106 and/or second liquid 108 change with temperature can reduce the amount of translation and/or bowing experienced by first outer layer 118 (e.g., first window 114 and/or the flexure) to accommodate expansion or contraction of the liquids, which can improve the optical performance of liquid lens 100 (e.g., by reducing the change in focus caused by a change in shape of the first outer layer or a portion thereof). In some embodiments, a change in the specific volume of the liquid composition of first liquid 106 over a temperature range from 0° C. to 60° C. is at most 0.028 cm³/g. For example, the change in the specific volume of the liquid composition of first liquid 106 over the temperature range from 0° C. to 60° C. is 0.028 cm³/g, 0.027 cm³/g, 0.026 cm³/g, 0.025 cm³/g, 0.024 cm³/g, 0.023 cm³/g, 0.022 cm³/g, 0.021 cm³/g, 0.020 cm³/g, 0.019 cm³/g, 0.018 cm³/g, 0.017 cm³/g, or any ranges defined by the listed values.

In some embodiments, reducing the concentration of additives in first liquid 106 can improve the optical properties of the first liquid for use in liquid lens 100. For example, reducing the concentration of additives in first liquid 106 can increase the Abbe number of the first liquid, which can reduce chromatic aberration generated by liquid lens 100 and/or reduce the wavefront error of the liquid lens, thereby improving image quality. In some embodiments, the Abbe number of first liquid is at least 45. For example, the Abbe number of first liquid 106 can be 45, 46, 47, 48, 49, 50, 51, 52, 53, 54, 55, 56, 57, 58, 59, 60, >60, or any ranges defined by the listed values.

Although reducing the concentration of additives in first liquid 106 can increase the Abbe number of the first liquid, thereby improving the optical performance of liquid lens 100, it also can increase the refractive index of the first liquid, which can reduce the difference in refractive index between the first liquid and second liquid 108 (e.g., in embodiments in which the first liquid has a lower refractive index than the second liquid) and negatively impact the optical power of the liquid lens. However, because the increase in the Abbe number can be greater than the corresponding increase in refractive index of first liquid 106, the improvement in optical quality can outweigh the deterioration in optical power. In various embodiments, the refractive index can be measured at a wavelength of 589.3 nm. In some embodiments, a first refractive index of first liquid 106, measured at a wavelength of 589.3 nm, is at most 1.40. For example, the first refractive index of first liquid 106 can be <1.30, 1.30, 1.31, 1.32, 1.33, 1.34, 1.35, 1.36, 1.37, 1.38, 1.39, 1.40, or any ranges defined by the listed values. In some embodiments, the difference (e.g., an absolute value of the difference) between the first refractive index of first liquid 106 and a second refractive index of second liquid 108, measured at the wavelength of 589.3 nm, is at least 0.11. For example, the difference between the first refractive index of first liquid 106 and the second refractive index of second liquid 108 can be 0.11, 0.12, 0.13, 0.14, 0.15, 0.16, 0.17, 0.18, 0.19, 0.20, 0.21, 0.22, 0.23, 0.24, 0.25, >0.25, or any ranges defined by the listed values.

In some embodiments, reducing the concentration of additives in first liquid 106 can improve the physical properties of the first liquid for use in liquid lens 100. For example, reducing the concentration of additives in first liquid 106 can reduce the viscosity of first liquid 106, which can improve the performance of liquid lens 100 (e.g., by decreasing the response time). In some embodiments, first liquid 106 comprises a viscosity of at most 4 cSt at 20° C. For example, the viscosity of first liquid 106 at 20° C. can be <1 cSt, 1 cSt, 1.1 cSt, 1.2 cSt, 1.3 cSt, 1.4 cSt, 1.5 cSt, 1.6 cSt, 1.8 cSt, 2 cSt, 2.2 cSt, 2.4 cSt, 2.6 cSt, 2.8 cSt, 3 cSt, 3.2 cSt, 3.4 cSt, 3.6 cSt, 3.8 cSt, 4 cSt, or any ranges defined by the listed values.

In some embodiments, reducing the concentration of additives in first liquid 106 can increase the surface tension between first liquid 106 and second liquid 108, which can improve the performance of liquid lens 100 (e.g., by decreasing the wavefront error and/or the hysteresis). In some embodiments, a surface tension between first liquid 106 and second liquid 108 is at least 20 mN/m. For example, the surface tension between first liquid 106 and second liquid 108 can be 20 mN/m, 22 mN/m, 24 mN/m, 26 mN/m, 28 mN/m, 30 mN/m, 32 mN/m, 34 mN/m, 36 mN/m, 38 mN/m, 40 mN/m, >40 mN/m, or any ranges defined by the listed values.

In some embodiments, reducing the concentration of additives in first liquid 106 can enabled liquid lens 100 to have improved performance characteristics. Although a variety of factors can impact the performance characteristics of liquid lens 100, use of first liquid 106 with a reduced concentration of additives as described herein can improve performance characteristics of the liquid lens compared to an otherwise identical liquid lens comprising a first liquid with an increased concentration of additives. In some embodiments, a focus response time of liquid lens 100 (e.g., comprising first liquid 106 described herein) is at most 80 ms. For example, the focus response time of liquid lens 100 is <10 ms, 10 ms, 15 ms, 20 ms, 25 ms, 30 ms, 35 ms, 40 ms, 45 ms, 50 ms, 55 ms, 60 ms, 65 ms, 70 ms, 75 ms, 80 ms, or any ranges defined by the listed values. Additionally, or alternatively, a tilt response time of liquid lens 100 (e.g., comprising first liquid 106 described herein) is at most 80 ms. For example, the tilt response time of liquid lens 100 is <10 ms, 10 ms, 15 ms, 20 ms, 25 ms, 30 ms, 35 ms, 40 ms, 45 ms, 50 ms, 55 ms, 60 ms, 65 ms, 70 ms, 75 ms, 80 ms, or any ranges defined by the listed values.

In some embodiments, second liquid 108 comprises a non-conductive liquid that is immiscible or substantially immiscible with first liquid 106. For example, second liquid 108 comprises a Si-based monomer or oligomer, a Ge-based monomer or oligomer, a Si—Ge-based monomer or oligomer, a hydrocarbon, or a mixture thereof.

In some embodiments, the configuration of liquid lens 100 can enable use of first liquid 106 with higher melting temperatures than conventional aqueous liquids for use in liquid lenses as described herein. For example, the geometry and/or physical properties of liquid lens 100 can enable first liquid 106 to be cooled below the melting point without freezing (e.g., to be supercooled).

In some embodiments, the volume of cavity 104 is relatively small, which can help to prevent first liquid 106 from freezing, even at temperatures below the melting point of the liquid composition of the first liquid. In some embodiments, the volume of cavity 104 is at most about 10 μL. For example, the volume of cavity 104 is 30 μL, 25 μL, 20 μL, 15 μL, 10 μL, 9 μL, 8 μL, 7 μL, 6 μL, 5 μL, 4 μL, 3 μL, 2 μL, 1 μL, or any ranges defined by the listed values.

In some embodiments, the surface roughness of the interior of cavity 104 in contact with first liquid 106 and/or second liquid 108 is relatively low, which can help to prevent the first liquid from freezing, even at temperatures below the melting point of the liquid composition of the first liquid. For example, a smooth interior surface of cavity 104 can be free or substantially free of nucleation points at which solid particles would tend to form, thereby helping to prevent first liquid 106 from freezing at such low temperatures. In some embodiments, a sidewall of cavity 104 (e.g., defined by a surface of insulating layer 132, conductive layer 128, first outer layer 118, and/or first window 114 in contact with first liquid 106 and/or second liquid 108) can be sufficiently smooth to prevent the first liquid from freezing, even at low operating temperatures. In some embodiments, the surface roughness of the interior of cavity 104 is at most about 300 nm. For example, the surface roughness of the interior of cavity 104 is 300 nm, 290 nm, 280 nm, 270 nm, 260 nm, 250 nm, 240 nm, 230 nm, 220 nm, 210 nm, 200 nm, 190 nm, 180 nm, 170 nm, 160 nm, 150 nm, 140 nm, 130 nm, 120 nm, 110 nm, 100 nm, 90 nm, 80 nm, 70 nm, 60 nm, 50 nm, 40 nm, 30 nm, 20 nm, or any ranges defined by the listed values.

Such low surface roughness of the interior of cavity 104 can be enabled by producing the bore in intermediate layer 120 with low surface roughness, depositing conductive layer 128 with low surface roughness on the intermediate layer, and/or depositing insulating layer 132 with low surface roughness on the conductive layer. For example, the bore in intermediate layer 120 can be produced by hot pressing, laser ablation, grit blasting, polishing (e.g., mechanical and/or laser polishing), diamond turning, or another suitable forming process capable of achieving low surface roughness. Additionally, or alternatively, conductive layer 128 and/or insulating layer 132 can be deposited by vapor deposition (e.g., chemical vapor deposition or physical vapor deposition), atomic layer deposition, spray coating, dip coating, or another suitable deposition process capable of achieving low surface roughness.

### EXAMPLES

Various embodiments will be further clarified by the following examples.

Table 1 provides the compositions and selected properties of exemplary liquid compositions prepared for use as first liquid 106 in liquid lens 100. The refractive indices reported in Table 1 were measured at a wavelength of 589.3 nm. The melting points reported in Table 1 were measured at standard pressure. Unless otherwise noted or indicated by context, the physical properties reported in Table 1 were measured at room temperature.

TABLE 1
Exemplary Liquid Compositions and Selected Properties

| Example | 1 | 2 | 3 | 4 | 5 |
|---|---|---|---|---|---|
| Water (wt. %) | 47 | | 85 | 84 | 77 |
| Sodium Bromide (wt. %) | 3 | | 10 | | |
| Sodium Sulfate (wt. %) | | | | 4 | 4 |
| Potassium Acetate (wt. %) | | 4 | | | |
| Ethylene Glycol (wt. %) | 50 | 96 | 5 | 12 | 19 |
| 1,3-Propanediol (wt. %) | | | | | |
| Glycerol (wt. %) | | | | | |
| Pentanol (wt. %) | | | | | |
| Melting Point (° C.) | | | | | |
| Viscosity (cSt) | | | | | |
| Refractive Index | | | | | |
| Abbe Number | | | | | |
| Specific Density @ 0° C. (cm³/g) | 0.909 | 0.876 | 0.915 | 0.947 | 0.937 |
| Specific Density @ 20° C. (cm³/g) | | | | | |
| Specific Density @ 60° C. (cm³/g) | 0.938 | 0.909 | 0.935 | 0.969 | 0.961 |
| Δ Specific Density 0° C.-60° C. | 0.029 | 0.033 | 0.02 | 0.02 | 0.024 |
| (cm³/g) | | | | | |

| Example | 6 | 7 | 8 | 9 | 10 |
|---|---|---|---|---|---|
| Water (wt. %) | 75 | 65 | 75 | 75 | 74.5 |
| Sodium Bromide (wt. %) | | | | | 8.5 |
| Sodium Sulfate (wt. %) | | 4 | 5 | 5 | |
| Potassium Acetate (wt. %) | 25 | | | | |
| Ethylene Glycol (wt. %) | | 31 | | | 17 |
| 1,3-Propanediol (wt. %) | | | 20 | | |
| Glycerol (wt. %) | | | | 20 | |
| Pentanol (wt. %) | | | | | |
| Melting Point (° C.) | | | | | −10 |
| Viscosity (cSt) | | | | | 1.758 |
| Refractive Index | | | | | 1.36246 |
| Abbe Number | | | | | 53.46 |
| Specific Density @ 0° C. (cm³/g) | 0.881 | 0.922 | 0.939 | 0.908 | |
| Specific Density @ 20° C. (cm³/g) | | | | | 0.921 |
| Specific Density @ 60° C. (cm³/g) | 0.901 | 0.948 | 0.962 | 0.930 | |
| Δ Specific Density 0° C.-60° C. | 0.02 | 0.026 | 0.023 | 0.022 | |
| (cm³/g) | | | | | |

| Example | 11 | 12 | 13 | 14 | 15 |
|---|---|---|---|---|---|
| Water (wt. %) | 77.5 | 85 | 79 | 84 | 85 |
| Sodium Bromide (wt. %) | | 2 | 9 | | 10 |
| Sodium Sulfate (wt. %) | 3.5 | | | 4 | |
| Potassium Acetate (wt. %) | | | | | |
| Ethylene Glycol (wt. %) | 19 | 13 | 12 | 12 | 5 |
| 1,3-Propanediol (wt. %) | | | | | |
| Glycerol (wt. %) | | | | | |
| Pentanol (wt. %) | | | | | |
| Melting Point (° C.) | −10 | −5 | −5 | −5 | 0 |
| Viscosity (cSt) | | | 1.5295 | | 1.3525 |
| Refractive Index | 1.35694 | 1.34834 | 1.3582 | 1.35068 | 1.35245 |
| Abbe Number | 56.79 | 55.45 | 52.98 | 56.46 | 52.37 |
| Specific Density @ 0° C. (cm³/g) | | | | | |
| Specific Density @ 20° C. (cm³/g) | | | 0.921 | | 0.921 |
| Specific Density @ 60° C. (cm³/g) | | | | | |
| Δ Specific Density 0° C.-60° C. | | | | | |
| (cm³/g) | | | | | |

| Example | 16 | 17 | 18 | 19 |
|---|---|---|---|---|
| Water (wt. %) | 93 | 84.75 | 46.75 | 96.75 |
| Sodium Bromide (wt. %) | 2 | 10 | 3 | 3 |
| Sodium Sulfate (wt. %) | | | | |
| Potassium Acetate (wt. %) | | | | |
| Ethylene Glycol (wt. %) | 5 | 5 | 50 | |
| 1,3-Propanediol (wt. %) | | | | |
| Glycerol (wt. %) | | | | |
| Pentanol (wt. %) | | 0.25 | 0.25 | 0.25 |
| Melting Point (° C.) | 0 | 0 | | |
| Viscosity (cSt) | | 1.27 | 3.8 | |
| Refractive Index | 1.34051 | 1.35294 | 1.388 | |
| Abbe Number | 55.17 | 52.73 | 58.5 | |
| Specific Density @ 0° C. (cm³/g) | | | | |
| Specific Density @ 20° C. (cm³/g) | | | 0.918 | |
| Specific Density @ 60° C. (cm³/g) | | | | |
| Δ Specific Density 0° C.-60° C. | | | | |
| (cm³/g) | | | | |

Liquid lenses 100 having the general configuration shown in FIG. 1 and comprising different first liquids 106 were constructed.

For comparison, liquid lenses having the general configuration shown in FIG. 4 of U.S. Pat. No. 7,515,350, which is incorporated herein by reference in its entirety, also were constructed. The liquid lens configuration was the configuration commercially available under the trade name A-25H from Corning® Varioptic® Lenses (Lyon, France), and the liquid composition shown in Table 1 as Example 17 was used as the first liquid.

### Example 1

Two liquid lenses were constructed, each comprising the liquid composition shown in Table 1 as Example 17 as the first liquid. The first liquid lens had the general configuration shown in FIG. 1, and the second liquid lens had the general configuration shown in FIG. 4 of U.S. Pat. No. 7,515,350. Comparison showed that the first liquid lens was operable to adjust the focus of the liquid lens at a low operating temperature below 0° C., while the second liquid lens was not operable at the same low operating temperature (e.g., because the first liquid froze).

### Example 2

A liquid lens was constructed having the general configuration shown in FIG. 1 and comprising the liquid composition shown in Table 1 as Example 10 as the first liquid. The liquid lens was operable to adjust the focus of the liquid lens at a low operating temperature of −20° C.

### Example 3

A liquid lens was constructed having the general configuration shown in FIG. 1 and comprising the liquid composition shown in Table 1 as Example 13 as the first liquid. The liquid lens was operable to adjust the focus of the liquid lens at a low operating temperature of −20° C.

### Example 4

A liquid lens was constructed having the general configuration shown in FIG. 1 and comprising the liquid composition shown in Table 1 as Example 15 as the first liquid. The liquid lens was operable to adjust the focus of the liquid lens at a low operating temperature of −20° C.

It will be apparent to those skilled in the art that various modifications and variations can be made without departing from the spirit or scope of the claimed subject matter. Accordingly, the claimed subject matter is not to be restricted except in light of the attached claims and their equivalents.

What is claimed is:

1. A liquid lens comprising:
a cavity disposed between a first window and a second window;
a first liquid disposed in the cavity;
a second liquid disposed in the cavity; and
a variable interface disposed between the first liquid and the second liquid, thereby forming a variable lens;
wherein the liquid lens is operable to adjust a shape of the variable interface of the liquid lens at an operating temperature that is less than a melting point of a liquid composition of the first liquid at a standard pressure of 1 atm; and
wherein a change in a specific volume of the liquid composition of the first liquid over a temperature range from 0° C. to 60° C. at the standard pressure of 1 atm is at most 0.028 cm3/g.

2. The liquid lens of claim 1, wherein:
the operating temperature is −20° C.; and
the melting point of the liquid composition of the first liquid at the standard pressure of 1 atm is greater than or equal to −10° C.

3. The liquid lens of claim 1, wherein:
the operating temperature is −20° C.; and
the melting point of the liquid composition of the first liquid at the standard pressure of 1 atm is greater than or equal to −5° C.

4. The liquid lens of claim 1, wherein the liquid lens is operable to change at least one of a focus or a tilt of the variable lens at the operating temperature that is less than the melting point of the liquid composition of the first liquid at the standard pressure of 1 atm.

5. The liquid lens of claim 1, the liquid composition of the first liquid comprising:
at least 65 wt. % water;
at most 31 wt. % of a freezing point reducing agent; and
at most 20 wt. % of an alkali metal salt.

6. The liquid lens of claim 1, the liquid composition of the first liquid comprising:
at least 80 wt. % water;
1 wt. % to 7 wt. % of a freezing point reducing agent; and
1 wt. % to 12 wt. % of an alkali metal salt;
wherein the combined concentration of water, the freezing point reducing agent, and the alkali metal salt in the liquid composition of the first liquid is at least 99 wt. %.

7. The liquid lens of claim 1, wherein:
a first refractive index of the first liquid, measured at a wavelength of 589.3 nm, is at most 1.40; and
an Abbe number of the first liquid is at least 45.

8. The liquid lens of claim 7, wherein a difference between the first refractive index of the first liquid and a second refractive index of the second liquid, measured at a wavelength of 589.3 nm, is at least 0.11.

9. The liquid lens of claim 7, wherein a difference between the first refractive index of the first liquid and a second refractive index of the second liquid, measured at a wavelength of 589.3 nm, is at least 0.14.

10. The liquid lens of claim 1, wherein a volume of the cavity is at most 10 μL.

11. The liquid lens of claim 1, wherein a volume of the cavity is at most 4 μL.

12. The liquid lens of claim 1, wherein a surface roughness of a sidewall of the cavity is at most 300 nm.

13. The liquid lens of claim 1, wherein at the operating temperature, the first liquid disposed in the cavity is supercooled.

14. The liquid lens of claim 1, the liquid composition of the first liquid comprising a viscosity of at most 1.3 cSt, measured at a temperature of 20° C.

15. A liquid lens comprising:
a cavity disposed between a first window and a second window;
a first liquid disposed in the cavity;
a second liquid disposed in the cavity; and
a variable interface disposed between the first liquid and the second liquid, thereby forming a variable lens;
wherein a viscosity of the first liquid is at most 1.3 cSt, measured at a temperature of 20° C.;
wherein a refractive index of the first liquid, measured at a wavelength of 589.3 nm, is at most 1.4;
wherein an Abbe number of the first liquid is at least 45;
wherein a volume of the cavity is at most 10 μL; and
wherein a change in a density of a liquid composition of the first liquid over a temperature range from 0° C. to 60° C. at a standard pressure of 1 atm is at most 0.028 cm3/g.

16. The liquid lens of claim 15, wherein a freezing point of the liquid composition of the first liquid disposed in the cavity is at least 10° C. less than a melting point of the liquid composition of the first liquid at the standard pressure of 1 atm.

17. The liquid lens of claim 15, a liquid composition of the first liquid comprising:
at least 65 wt. % water;
at most 31 wt. % of a freezing point reducing agent; and
at most 20 wt. % of an alkali metal salt.

18. The liquid lens of claim 15, a liquid composition of the first liquid comprising:
at least 80 wt. % water;
1 wt. % to 7 wt. % of a freezing point reducing agent; and
1 wt. % to 12 wt. % of an alkali metal salt;
wherein the combined concentration of water, the freezing point reducing agent, and the alkali metal salt in the liquid composition of the first liquid is at least 99 wt. %.

19. A liquid for use in a variable focus fluidic lens, the liquid comprising:
a liquid composition comprising at least 65 wt. % water, at most 31 wt. % of a freezing point reducing agent, and at most 20 wt. % of an alkali metal salt;
a melting point, measured at a standard pressure of 1 atm, of greater than or equal to −10° C.;
a viscosity of at most 1.3 cSt;
a refractive index, measured at a wavelength of 589.3 nm, of at most 1.4;
an Abbe number of at least 45; and
a change in density over a temperature range from 0° C. to 60° C. at the standard pressure of 1 atm of at most 0.028 cm³/g.

20. The liquid of claim 19, the liquid composition comprising:
at least 80 wt. % water;
1 wt. % to 7 wt. % of the freezing point reducing agent; and
1 wt. % to 12 wt. % of the alkali metal salt;
wherein the combined concentration of water, the freezing point reducing agent, and the alkali metal salt in the liquid composition is at least 99 wt. %.

21. The liquid of claim 19, wherein the freezing point reducing agent is selected from the group consisting of a diol, a triol, a sulfoxide, a lactone, and combinations thereof.

22. The liquid of claim 19, wherein the freezing point reducing agent is selected from the group consisting of ethylene glycol, propylene glycol, 1,3-propanediol, glycerol, dimethyl sulfoxide (DMSO), ethyl-lactate, γ-butyrolactone, and combinations thereof.

23. The liquid of claim 19, wherein the alkali metal salt is selected from the group consisting of an alkali metal bromide, an alkali metal acetate, an alkali metal sulfate, and combinations thereof.

24. The liquid composition of claim 19, wherein the alkali metal salt is selected from the group consisting of lithium bromide, sodium bromide, potassium acetate, sodium sulfate, and combinations thereof.
